(19) United States
(12) Patent Application Publication
(10) Pub. No.: US 2008/0079707 A1
(43) Pub. Date: Apr. 3, 2008

(54) Signal transfer circuit, display data processing apparatus, and display apparatus

(76) Inventors: Kazuya Matsumoto, Kyoto (JP); Jun Iitsuka, Kyoto (JP); Yoshihisa Hamahashi, Osaka (JP); Tomoya Ishikawa, Osaka (JP)

Correspondence Address: MCDERMOTT WILL & EMERY LLP, 600 13TH STREET, NW, WASHINGTON, DC, 20005-3096, US

(21) Appl. No.: 11/889,635

(22) Filed: Aug. 15, 2007

(30) Foreign Application Priority Data
Sep. 29, 2006 (JP) 2006-267655
May 21, 2007 (JP) 2007-133861

(51) Int. Cl. G06F 3/038

(52) U.S. Cl. 345/211

(57) ABSTRACT

First and second input/output circuits each have an input terminal connected to the input node. A first power supply wiring supplies a first voltage. A second power supply wiring supplies a second voltage. The first and second input/output circuits each select any one of the first and second power supply wirings, depending on the polarity of an input signal, to output an output signal. The first and second input/output circuits each have any one of a first characteristic in which an output signal having the same polarity as that of the input signal is output and a second characteristic in which an output signal having a polarity opposite to that of the input signal is output. The characteristics possessed by the first and second input/output circuits are different from each other.

### BACKGROUND OF THE INVENTION

1. Field of the Invention

The present invention relates to a circuit for transferring a signal, and a display data processing apparatus and a display apparatus comprising the signal transfer circuit.

2. Description of the Related Art

Conventionally, a buffer circuit is provided for a signal wiring connecting circuits so as to accurately transfer the logic level of a signal between the circuits or prevent backflow of a current. The buffer circuit is connected to a high-level power supply wiring and a low-level power supply wiring. A signal to be transferred is input to an input terminal of the buffer circuit. Also, a circuit to which the signal is to be transferred is connected to a signal wiring extending from an output terminal of the buffer circuit. For example, in a display panel driving apparatus, a display data signal is input to the input terminal of the buffer circuit while a plurality of stages of latch circuits for latching the display data signal with predetermined timing are connected to the signal wiring extending from the output terminal of the buffer circuit.

In such a buffer circuit, when a signal input to the input terminal goes from the low level to the high level, a current is supplied from the high-level power supply wiring to the output terminal of the buffer circuit. Thereby, the load capacitance (the capacitance of the signal wiring, the capacitance of the circuit connected to the signal wiring, etc.) of the buffer circuit is charged, so that a high-level signal is transferred. Conversely, when the input signal goes from the high level to the low level, a current is extracted from the output terminal of the buffer circuit to the low-level power supply wiring. Thereby, the load capacitance of the buffer circuit is discharged, so that a low-level signal is transferred.

Also, the high-level power supply wiring and the low-level power supply wiring each have resistance. Therefore, when a charging operation is performed by the buffer circuit, a voltage drop (so-called IR drop) occurs in the high-level power supply wiring. When a discharging operation is performed by the buffer circuit, a voltage increase occurs in the low-level power supply wiring. Thus, a voltage variation occurs in the power supply wiring due to a charging or discharging operation performed by the buffer circuit.

In recent years, as the packing density of a circuit is increased, the number of signal wirings in the integrated circuit or the number of circuits connected to each signal wiring tends to increase. For example, there is an increasing demand for a higher resolution of display panels. In display panel driving apparatuses, the number of signal wirings for transferring a display data signal or the number of latch circuits connected to a signal wiring is increased. Thereby, the load capacitance of the buffer circuit increases, so that the current driving performance of the buffer circuit needs to be enhanced (i.e., the amount of a charged or discharged current flowing through the buffer circuit needs to be increased). Therefore, the amount of a variation in voltage of the power supply wiring which occurs due to charging or discharging of the buffer circuit increases, leading to a deterioration in ElectroMagnetic Interference (EMI). Also, since the voltage variation amount of the power supply wiring is large, it is difficult to increase the operating frequency.

In particular, in display panels, such as liquid crystal displays Organic ElectroLuminescence displays, Inorganic ElectroLuminescence displays, FEDs (Field Emission Displays), Surface-conduction Electron-emitter Displays (SEDs), PDPs (Plasma Display Panels), and the like, since it is important to address EMI, the above-described problems are strongly desired to be solved.

### SUMMARY OF THE INVENTION

To solve the above-described problems, an object of the present invention is to reduce the voltage variation of the power supply wiring.

According to an aspect of the present invention, a signal transfer circuit for transferring a signal input to an input node, comprises a first input/output circuit and a second input/output circuit each having an input terminal connected to the input node, a first signal wiring extending from an output terminal of the first input/output circuit, a second signal wiring extending from an output terminal of the second input/output circuit, a first power supply wiring for supplying a first voltage, and a second power supply wiring for supplying a second voltage which is lower than the first voltage. The first and second input/output circuits each select any one of the first and second power supply wirings, depending on the polarity of an input signal, to output an output signal, and have any one of a first characteristic in which an output signal having the same polarity as that of the input signal is output and a second characteristic in which an output signal having a polarity opposite to that of the input signal is output. The characteristics possessed by the first and second input/output circuits are different from each other.

In the signal transfer circuit, when the polarity of the signal input to the input node is transitioned, the first and second input/output circuits perform operations reverse to each other. For example, the first input/output circuit performs a charging operation, while the second input/output circuit performs a discharging operation. Thereby, voltage variations caused by the first and second input/output circuits occur the respective different power supply wirings. Thus, charging and discharging of the load capacitance are shared by the first and second input/output circuits which perform the respective reverse operations, thereby making it possible to reduce a voltage variation of each of the first and power supply wirings.

According to another aspect of the present invention, a signal transfer circuit for transferring a signal input to an input node, comprises a first input/output circuit and a second input/output circuit each having an input terminal connected to the input node, a first signal wiring extending from an output terminal of the first input/output circuit, a second signal wiring extending from an output terminal of the second input/output circuit, a third input/output circuit provided for the first signal wiring, a first power supply wiring for supplying a first voltage, and a second power supply wiring for supplying a second voltage which is lower than the first voltage. The first, second and third input/output circuits each select any one of the first and second power supply wirings, depending on the polarity of an input signal, to output an output signal. The first and second input/output circuits have any one of a first characteristic in which an output signal having the same polarity as that of the input signal is output and a second characteristic in which an output signal having a polarity opposite to that of the input signal is output. The characteristics possessed by the first and second input/output circuits are the same. The third input/output circuit has the second characteristic.

In the signal transfer circuit, when the polarity of the signal input to the input node is transitioned, the third input/output circuit performs an operation reverse to that of the first and second input/output circuits. Thus, charging and discharging of the load capacitance are shared by the first, second and third input/output circuits, thereby making it possible to reduce a voltage variation of each of the first and power supply wirings.

According to another aspect of the present invention, a signal transfer circuit for transferring a signal input to an input node, comprises a first input/output circuit having an input terminal connected to the input node, a signal wiring extending from an output terminal of the first input/output circuit, a second input/output circuit provided for the signal wiring, a first power supply wiring for supplying a first voltage, and a second power supply wiring for supplying a second voltage which is lower than the first voltage. The first and second input/output circuits each select any one of the first and second power supply wirings, depending on the polarity of an input signal, to output an output signal. The first input/output circuit has any one of a first characteristic in which an output signal having the same polarity as that of the input signal is output and a second characteristic in which an output signal having a polarity opposite to that of the input signal is output. The second input/output circuit has the second characteristic.

In the signal transfer circuit, when the polarity of the signal input to the input node is transitioned, the second input/output circuit performs an operation reverse to that of the first input/output circuit. Thus, charging and discharging of the load capacitance are shared by the first and second input/output circuits, thereby making it possible to reduce a voltage variation of each of the first and power supply wirings.

### BRIEF DESCRIPTION OF THE DRAWINGS

FIG. 1 is a diagram for describing a configuration of a signal transfer circuit according to a first embodiment of the present invention.

FIG. 2 is a diagram showing exemplary configurations of a buffer circuit and an inverter circuit of FIG. 1.

FIG. 3 is a signal waveform diagram for describing an operation of the signal transfer circuit of FIG. 1.

FIG. 4 is a diagram showing a variation of the signal transfer circuit of FIG. 1.

FIG. 5 is a signal waveform diagram for describing an operation of the signal transfer circuit of FIG. 4.

FIG. 6 is a diagram for describing a configuration of a signal transfer circuit according to a second embodiment of the present invention.

FIG. 7 is a signal waveform diagram for describing an operation of the signal transfer circuit of FIG. 6.

FIG. 8 is a diagram showing a variation of the signal transfer circuit of FIG. 6.

FIG. 9 is a diagram for describing a configuration of a signal transfer circuit according to a third embodiment of the present invention.

FIG. 10 is a signal waveform diagram for describing an operation of the signal transfer circuit of FIG. 9.

FIG. 11 is a diagram for describing a configuration of a signal transfer circuit according to a fourth embodiment of the present invention.

FIG. 12 is a diagram showing an exemplary configuration of a control signal generating circuit of FIG. 11.

FIG. 13 is a signal waveform diagram for describing an operation of the signal transfer circuit of FIG. 11.

FIG. 14 is a diagram for describing a configuration of a signal transfer circuit according to a fifth embodiment of the present invention.

FIG. 15 is a diagram showing an exemplary configuration of a control signal generating circuit of FIG. 14.

FIG. 16 is a signal waveform diagram for describing an operation of the signal transfer circuit of FIG. 14.

FIG. 17 is a diagram for describing an exemplary display apparatus to which the signal transfer circuit of each embodiment is applied.

FIG. 18 is a diagram for describing connection between latch circuits and level shift circuits.

FIG. 19 is a diagram showing an exemplary configuration of the level shift circuit of FIG. 18.

### DETAILED DESCRIPTION OF THE PREFERRED EMBODIMENTS

Hereinafter, embodiments of the present invention will be described with reference to the accompanying drawings.

### First Embodiment

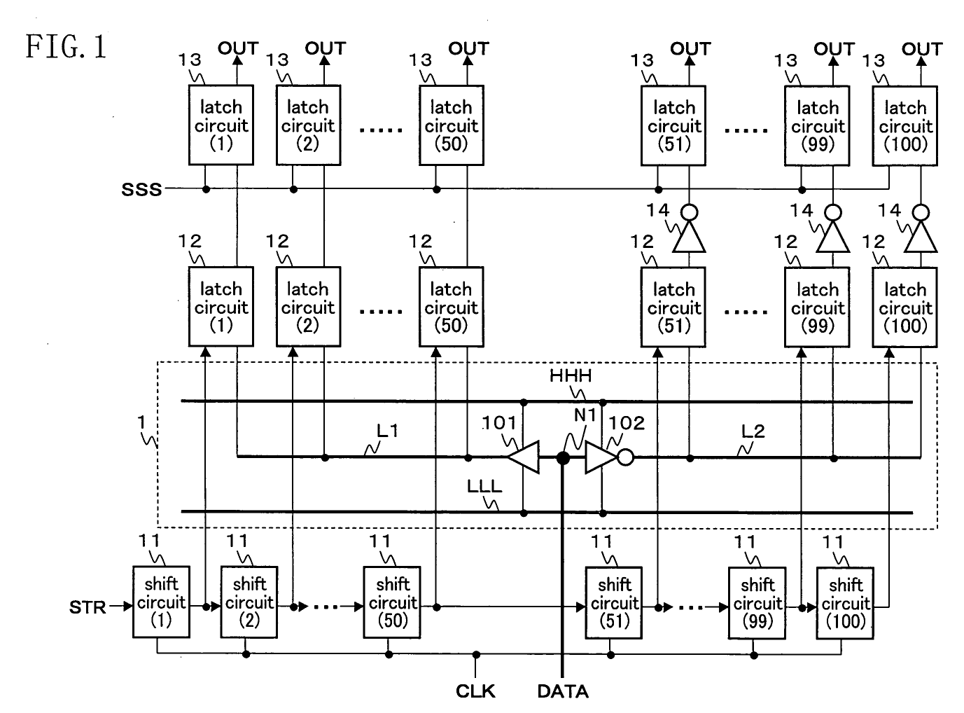

FIG. 1 shows a configuration of a signal transfer circuit according to a first embodiment of the present invention. Here, the signal transfer circuit 1 is used as a data bus for transferring a display data signal DATA to latch circuits 12 in a display panel driving apparatus. The signal transfer circuit 1 comprises a buffer circuit 101, an inverter circuit 102, signal wirings L1 and L2, a high-level power supply wiring HHH, and a low-level power supply wiring LLL. The buffer circuit 101 and the inverter circuit 102 each have an input terminal connected to an input node N1 to which the display data signal DATA is input. The signal wiring L1 extends from an output terminal of the buffer circuit 101, while the signal wiring L2 extends from an output terminal of the inverter circuit 102. Thus, a signal path of the signal transfer circuit 1 is bifurcated into the signal wirings L1 and L2 from the input node N1 as a bifurcation point. The high-level power supply wiring HHH is, for example, an aluminum wiring extending from a high-level power supply terminal, which supplies a high-level voltage. The low-level power supply wiring LLL is, for example, an aluminum wiring extending from a low-level power supply terminal, which supplies a low-level voltage which is lower than the high-level voltage.

In FIG. 1, the display panel driving apparatus comprises a plurality of shift circuits 11, a plurality of latch circuits 12, and a plurality of latch circuits 13 in addition to the signal transfer circuit 1.

The shift circuits 11 constitute a shift register. Each shift circuit 11 sequentially transfers a pulse signal from the previous stage to the next stage in synchronization with an internal clock signal CLK. Thereby, a start pulse signal STR is sequentially shifted. Each latch circuit 12 latches the display data signal DATA from a signal wiring connected thereto in synchronization with a pulse signal from the corresponding shift circuit 11. Each latch circuit 13 latches the display data signal DATA held by the corresponding latch circuit 12 in synchronization with a second latch signal SSS, and outputs a digital signal OUT indicating a luminance level of one pixel. Thereby, the digital signal OUT is output from all of the latch circuits 13 simultaneously. Also, in general display panel driving apparatuses, for each latch circuit 13, a level shift circuit and a digital-to-analog conversion circuit are provided, though not shown in FIG. 1. The level shift circuit converts a voltage level of the digital signal OUT from the corresponding latch circuit 13. The digital-to-analog conversion circuit outputs a gray-scale voltage having a voltage value depending on a digital signal from the corresponding level shift circuit. Thereby, a plurality of gray-scale voltages are output in parallel from the display panel driving apparatus.

Note that, in FIG. 1, for the sake of simplicity, the display panel driving apparatus is assumed to comprise 100 stages of shift circuits 11, 100 stages of latch circuits 12, and 100 stages of latch circuits 13. It is also assumed that the first-stage to 50th-stage latch circuits 12 are connected to the signal wiring L1, while the 51st-stage to 100th-stage latch circuits 12 are connected to the signal wiring L2. Also, in order to bring the display data signal DATA inverted by the inverter circuit 102 back to the original polarity, an inverter circuit 14 is provided for each of the 51st-stage to 100th-stage latch circuits 12.

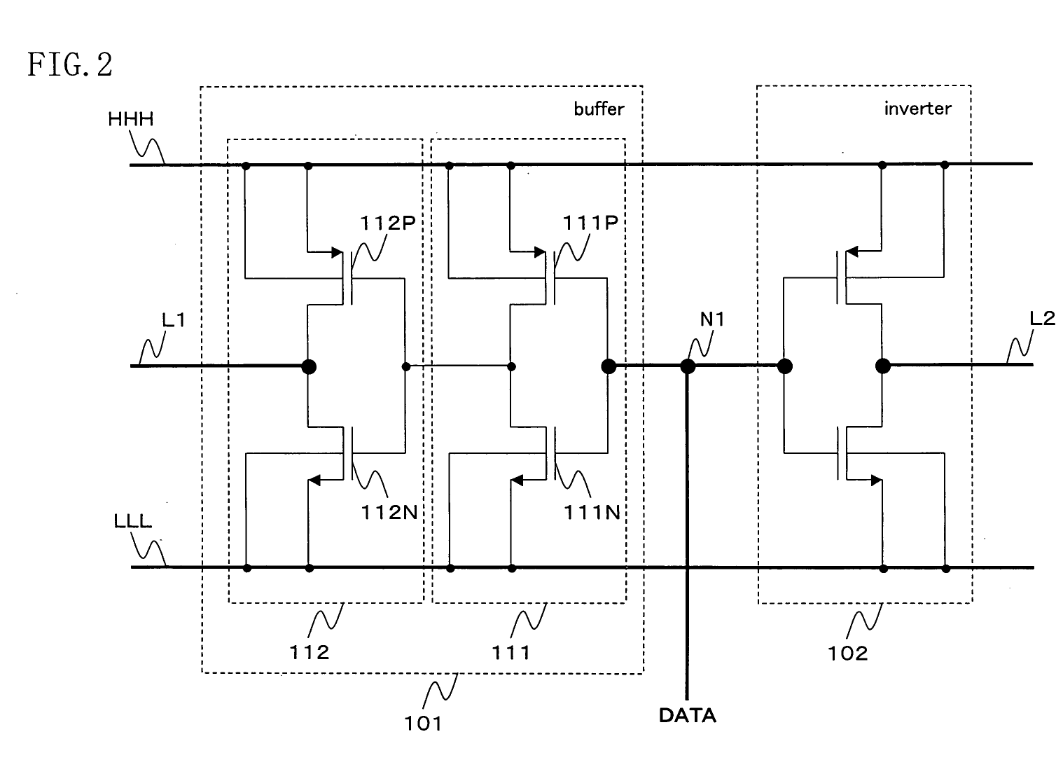

FIG. 2 shows internal configurations of the buffer circuit 101 and the inverter circuit 102 of FIG. 1. The buffer circuit 101 includes two inverter portions 111 and 112. A transistor capacitance, such as, mainly, a gate capacitance of the inverter portion 112 or the like, is added to an output of inverter portion 111. On the other hand, a wiring capacitance of the signal wiring L1 or a capacitance of the latch circuit 12 connected to the signal wiring L1 is added to an output of the inverter portion 112. A load capacitance of the inverter portion 111 (a capacitance to be charged or discharged by the inverter portion 111) is smaller than that of the inverter portion 112, and therefore, the current driving performance (the amount of a charging or discharging current flowing during charging or discharging) of the inverter portion 111 is designed to be smaller than that of the inverter portion 112. Specifically, transistors 111P and 111N included in the inverter portion 111 have a W/L (the ratio of a channel width to a channel length) which is smaller than that of transistors 112P and 112N included in the inverter portion 112. Therefore, in the buffer circuit 101, a charging or discharging current or a through current occurs mainly in the inverter portion 112.

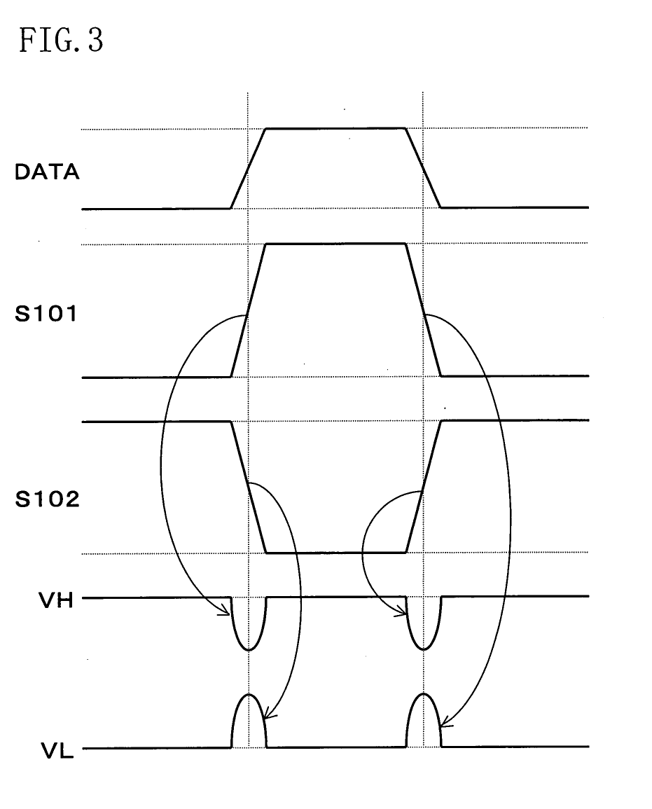

Next, an operation of the signal transfer circuit 1 of FIG. 1 will be described with reference to FIG. 3.

When the display data signal DATA goes from the low level to the high level, the buffer circuit 101 performs a charging operation. Specifically, in the buffer circuit 101, a current is supplied from the high-level power supply wiring HHH to the output terminal of the buffer circuit 101, so that the load capacitance (the wiring capacitance of the signal wiring L1 and the capacitance of the latch circuit 12 connected to the signal wiring L1) of the buffer circuit 101 is charged. Thereby, an output S101 of the buffer circuit 101 goes from the low level to the high level. Also, a voltage VH of the power supply wiring HHH varies due to the charging operation. On the other hand, the inverter circuit 102 performs a discharging operation. Specifically, in the inverter circuit 102, a current is extracted from the output terminal of the inverter circuit 102 to the low-level power supply wiring LLL, so that the load capacitance (the wiring capacitance of the signal wiring L2 and the capacitance of the latch circuit 12 connected to the signal wiring L2) of the inverter circuit 102 is discharged. Thereby, an output S102 of the inverter circuit 102 goes from the high level to the low level. Also, a voltage VL of the low-level power supply wiring LLL varies due to the discharging operation.

Conversely, when the display data signal DATA goes from the high level to the low level, the buffer circuit 101 performs a discharging operation, while the inverter circuit 102 performs a charging operation.

When the polarity (logic level) of the display data signal DATA is transitioned in this manner, the buffer circuit 101 and the inverter circuit 102 perform operations reverse to each other. In other words, a voltage variation caused by the buffer circuit 101 and a voltage variation caused by the inverter circuit 102 occur in the respective power supply wirings different from each other.

Also, the load capacitance of the whole signal path is distributed to the buffer circuit 101 and the inverter circuit 102. Therefore, the current driving performance of each of the buffer circuit 101 and the inverter circuit 102 can be caused to be smaller than when the load capacitance of the whole signal path is charged or discharged using a single buffer circuit or a single inverter circuit, so that both the voltage variations of the power supply wiring caused by the buffer circuit 101 and the inverter circuit 102 can be reduced. For example, when the buffer circuit 101 and the inverter circuit 102 have equal load capacitances, the current driving performance of each of the buffer circuit 101 and the inverter circuit 102 can be reduced by half, so that the voltage variation amount of each of the power supply wirings HHH and LLL can be reduced by half.

As described above, the charging and discharging of the load capacitance is shared by the buffer circuit 101 and the inverter circuit 102, and the buffer circuit 101 and the inverter circuit 102 perform operations reverse to each other, thereby making it possible to reduce the voltage variation of each of the power supply wirings HHH and LLL. Thereby, EMI can be reduced, so that the operating frequency can be increased. Further, since the voltage variation of the power supply wiring can be suppressed, each of the power supply wirings HHH and LLL can be caused to be thinner.

### Variation of First Embodiment

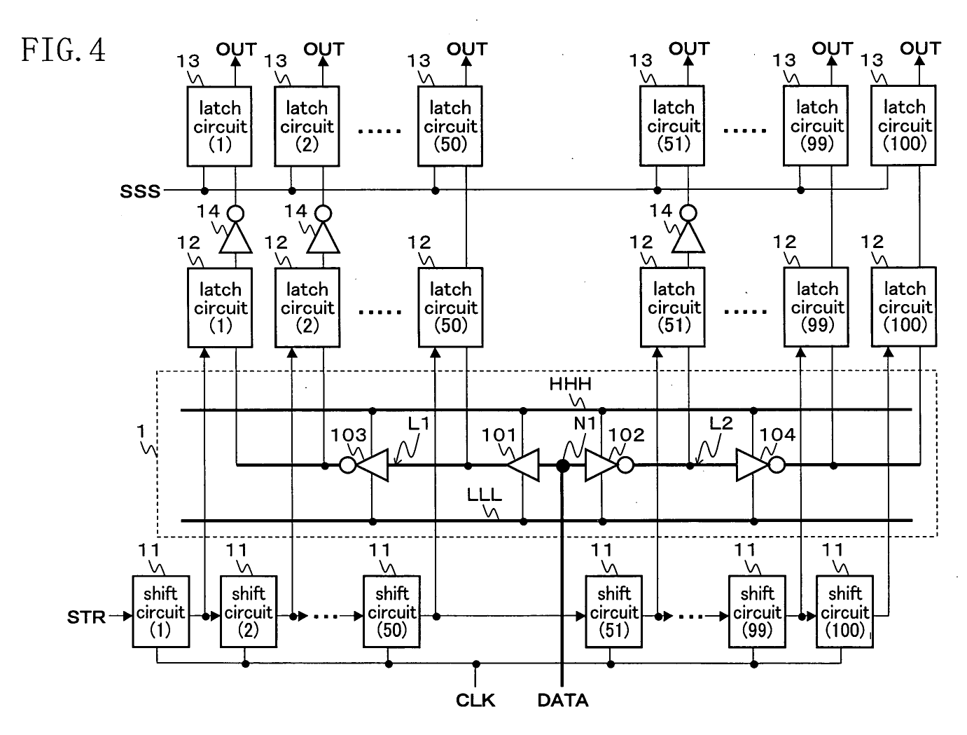

As shown in FIG. 4, the signal transfer circuit 1 may further comprise inverter circuits 103 and 104. The inverter circuit 103 is provided for the signal wiring L1, while the inverter circuit 104 is provided for the signal wiring L2. Note that it is here assumed that the 26th-stage to 50th-stage latch circuits 12 are connected to the signal wiring L1 between the buffer circuit 101 and the inverter circuit 103, while the 51st-stage to 75th-stage latch circuits 12 are connected to the signal wiring L2 between the inverter circuits 102 and 104. Also, in order to bring the display data signal DATA inverted by the inverter circuit 103 back to the original polarity, an inverter circuit 14 is provided for each of the first-stage to 25th-stage latch circuits 12. On the other hand, since the display data signal DATA inverted by the inverter circuit 102 is brought back to the original polarity by the inverter circuit 104, the inverter circuit 14 is not provided for any of the 76th to 100th latch circuits 12. The other portions are similar to those of FIG. 1.

Thus, by further providing the inverter circuits 103 and 104, a load capacitance per stage is further reduced. For example, when the buffer circuit 101 and the inverter circuits 102, 103 and 104 have equal load capacitances, a load capacitance per stage is ¼ of the load capacitance of the whole signal path. In other words, the current driving performance of each of the buffer circuit 101 and the inverter circuits 102, 103 and 104 can be reduced by a factor of ¼.

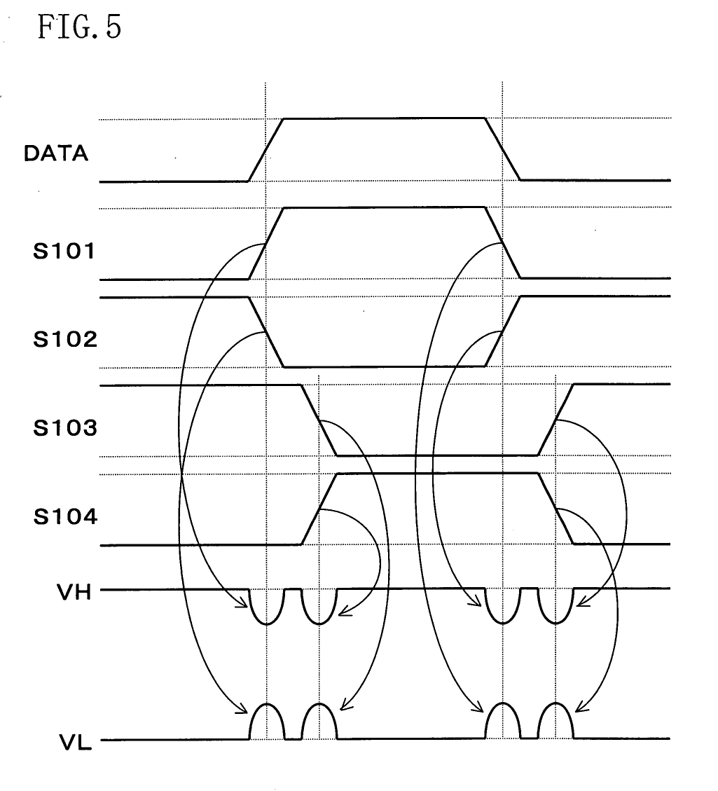

Next, an operation of the signal transfer circuit 1 of FIG. 4 will be described with reference to FIG. 5.

When the display data signal DATA goes from the low level to the high level, the output S101 of the buffer circuit 101 goes from the low level to the high level, so that the inverter circuit 103 performs a discharging operation. Thereby, an output S103 of the inverter circuit 103 goes from the high level to the low level. On the other hand, the output S102 of the inverter circuit 102 goes from the high level to the low level, so that the inverter circuit 104 performs a charging operation. Thereby, an output S104 of the inverter circuit 104 goes from the low level to the high level. Also, when the display data signal DATA goes from the high level to the low level, the buffer circuit 101 performs a discharging operation, and thereafter, the inverter circuit 103 performs a charging operation. On the other hand, the inverter circuit 102 performs a charging operation, and thereafter, the inverter circuit 104 performs a discharging operation.

Thus, the buffer circuit 101 starts a charging or discharging operation substantially at the same time when the inverter circuit 102 starts a charging or discharging operation. On the other hand, the inverter circuit 104 starts a charging or discharging operation with a delay from the operation of the inverter circuit 102 due to a delay in the inverter circuit 102 or a wiring delay in the signal wiring L2 between the inverter circuits 102 and 104. Specifically, when the polarity of the display data signal DATA is transitioned, the buffer circuit 101 and the inverter circuit 104 perform the same operation, but these operations are started with different timing. Therefore, voltage variations caused by the buffer circuit 101 and inverter circuit 104 occur in the same power supply wiring, but peaks of the voltage variations do not have the same timing. The same is true of the inverter circuits 102 and 103.

As described above, when charging and discharging of the load capacitance are further shared by the inverter circuits 103 and 104, a voltage variation can be distributed in the same power supply wiring, thereby making it possible to further reduce a voltage variation in each of the power supply wirings HHH and LLL.

Comparing with the configuration of FIG. 1, the current driving performance of each of the buffer circuit 101 and the inverter circuits 102, 103 and 104 can be reduced in the signal transfer circuit 1 of FIG. 4, so that each circuit scale can be reduced. In particular, even when an area for forming the buffer circuit 101 and the inverter circuit 102 is small, so that the current driving performance of the buffer circuit 101 and the inverter circuit 102 cannot be caused to be sufficiently large, the current driving performance can be supplemented by forming the inverter circuits 103 and 104 in an unused area.

Note that, if at least one of the inverter circuits 103 and 104 is provided, a voltage variation can be distributed in the same power supply wiring. Also, when the inverter circuits 103 and 104 are replaced with a buffer circuit, a similar effect can be obtained. Specifically, by adding an input/output circuit to both or either of the signal wirings L1 and L2, the above-described effect can be obtained. Here, the input/output circuit collectively refers to a buffer circuit and an inverter circuit which are a circuit for selecting any one of the power supply wirings HHH and LLL, depending on the polarity of a signal input to an input terminal of the circuit, and outputting an output signal. Also, not only a single stage of an input/output circuit but also a plurality of stages of input/output circuits may be provided for the signal wirings L1 and L2. As the number of stages of input/output circuits is increased, a load capacitance per stage can be reduced. Further, the numbers of stages of input/output circuits provided for the signal wirings L1 and L2 may or may not be the same.

### Second Embodiment

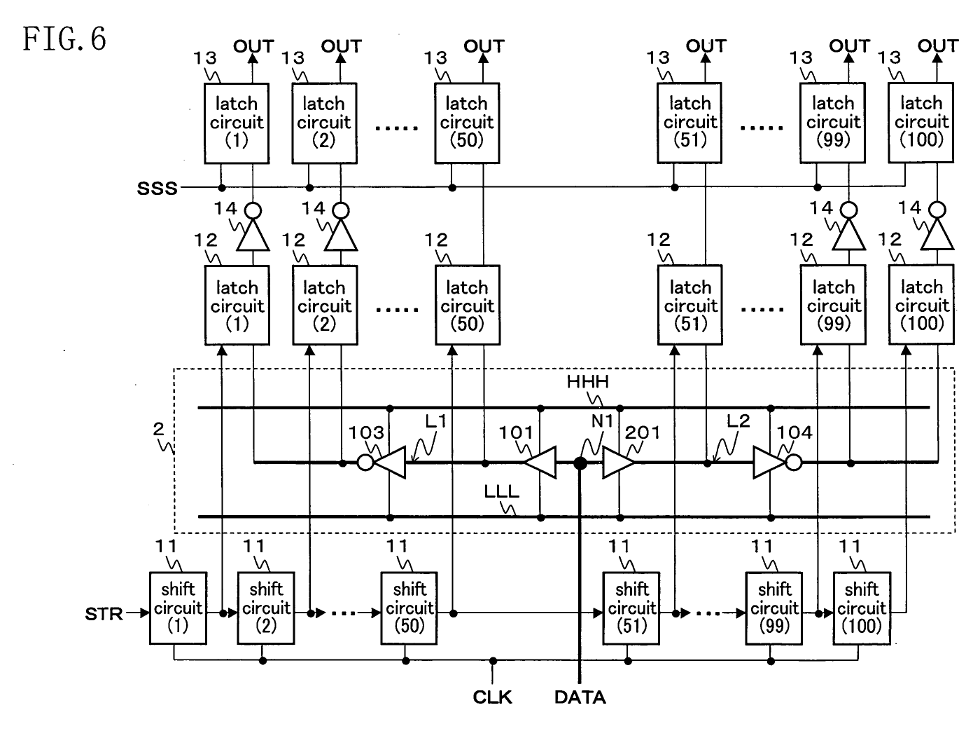

FIG. 6 shows a configuration of a signal transfer circuit according to a second embodiment of the present invention. This signal transfer circuit 2 comprises a buffer circuit 201 instead of the inverter circuit 102 of FIG. 4. Also, a display data signal DATA output from the buffer circuit 201 is not inverted, so that the inverter circuit 14 is not provided for any of the 51st-stage to 75th-stage latch circuits 12. On the other hand, in order to bring the display data signal DATA inverted by the inverter circuit 104 back to the original polarity, the inverter circuit 14 is provided for each of the 76th-stage to 100th-stage latch circuits 12. The other portions are similar to those of FIG. 4.

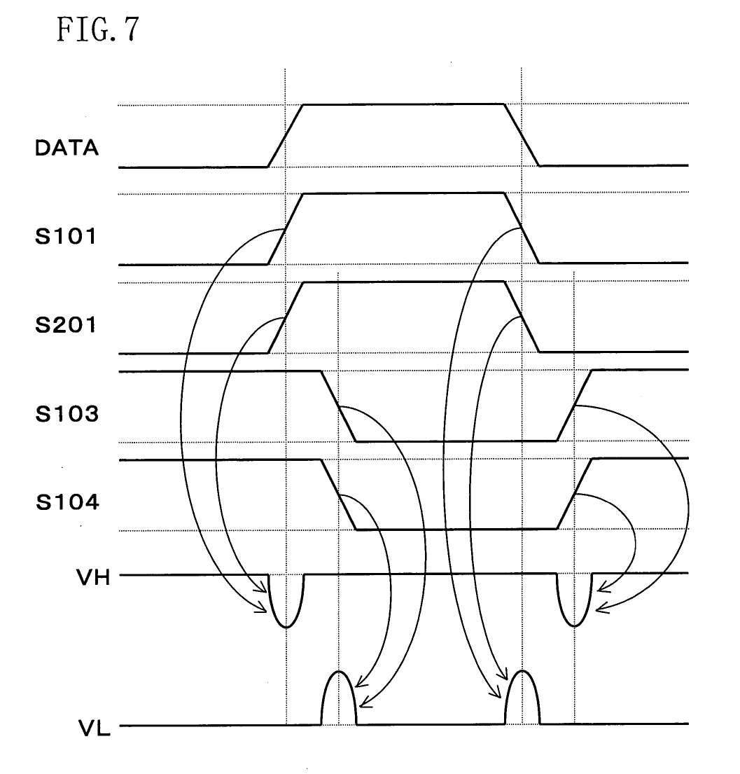

Next, an operation of the signal transfer circuit 2 of FIG. 6 will be described with reference to FIG. 7.

When the display data signal DATA goes from the low level to the high level, an output S201 of the buffer circuit 201 goes from the low level to the high level, so that the inverter circuit 104 performs a discharging operation. Thereby, the output S104 of the inverter circuit 104 goes from the high level to the low level. Also, when the display data signal DATA goes from the high level to the low level, the buffer circuit 201 performs a discharging operation, and thereafter, the inverter circuit 104 performs a charging operation.

The voltage VH of the power supply wiring HHH and the voltage VL of the power supply wiring LLL vary due to a charging or discharging operation performed by each of the buffer circuits 101 and 201 and the inverter circuits 103 and 104. Here, voltage variations caused by the buffer circuits 101 and 201 substantially simultaneously occur in the same power supply wiring. However, a load capacitance per stage is smaller than when a single stage of a buffer circuit or a single stage of an inverter circuit is used to charge or discharge the load capacitance of the whole signal path. Therefore, even if voltage variations caused by the buffer circuits 101 and 201 are superposed, the voltage variation amount is small. The same is true of the inverter circuits 102 and 104.

As described above, charging and discharging of the load capacitance are shared by the buffer circuits 101 and 201 and the inverter circuits 103 and 104, and the inverter circuits 103 and 104 perform operations reverse to those of the buffer circuits 101 and 201, so that the voltage variations of the power supply wirings HHH and LLL can be reduced.

Note that, if at least one of the inverter circuits 103 and 104 is provided, the effect of reducing the voltage variation amount can be obtained. Also, even when each of the buffer circuits 101 and 201 is replaced with an inverter circuit, a similar effect can be obtained.

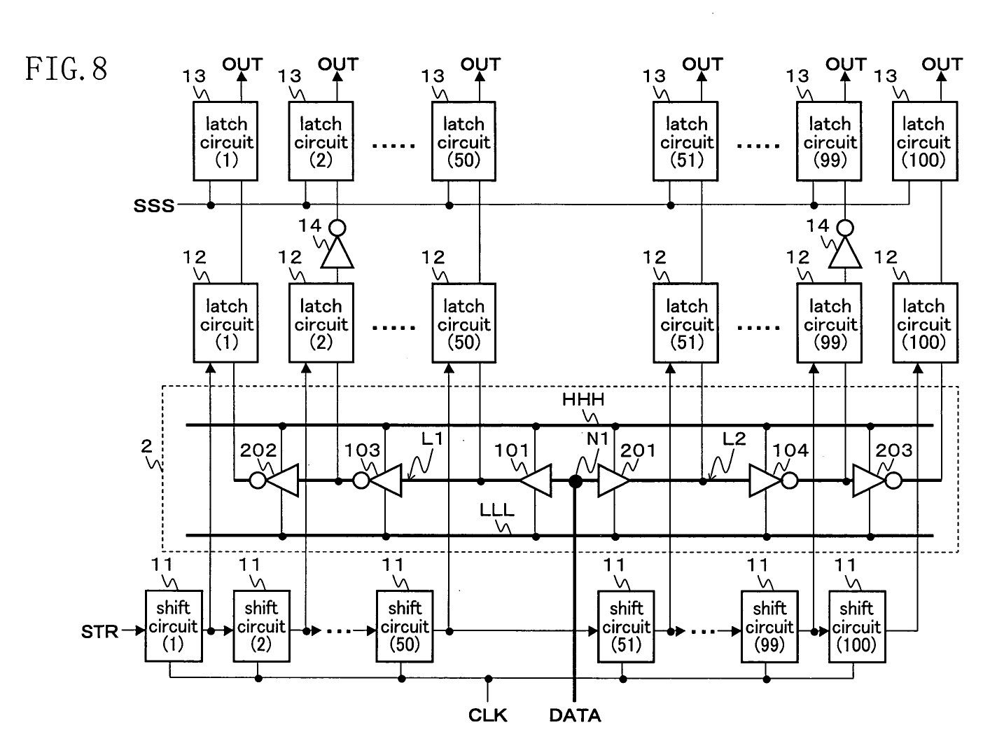

Further, as shown in FIG. 8, inverter circuits 202 and 203 may be added to the signal wirings L1 and L2, respectively, in addition to the inverter circuits 103 and 104. Also, a buffer circuit may be added.

### Third Embodiment

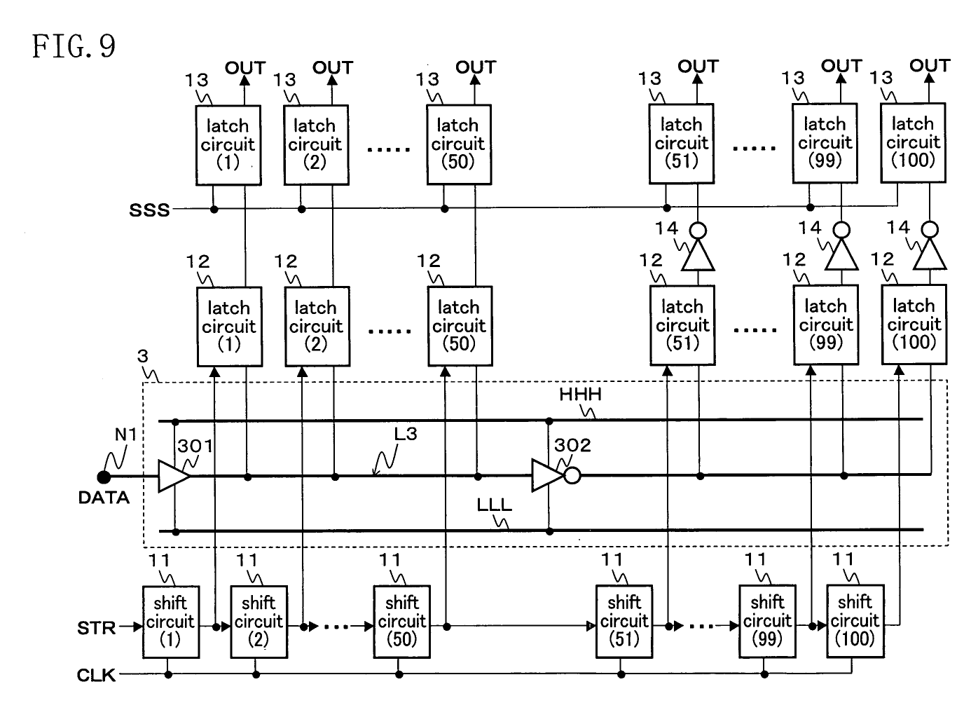

FIG. 9 shows a configuration of a signal transfer circuit according to a third embodiment of the present invention. This signal transfer circuit 3 comprises a buffer circuit 301, a signal wiring L3, and an inverter circuit 302. An input terminal of the buffer circuit 301 is connected to an input node N1. The signal wiring L3 extends from an output terminal of the buffer circuit 301. The inverter circuit 302 is provided for the signal wiring L3. The other portions are similar to those of FIG. 1.

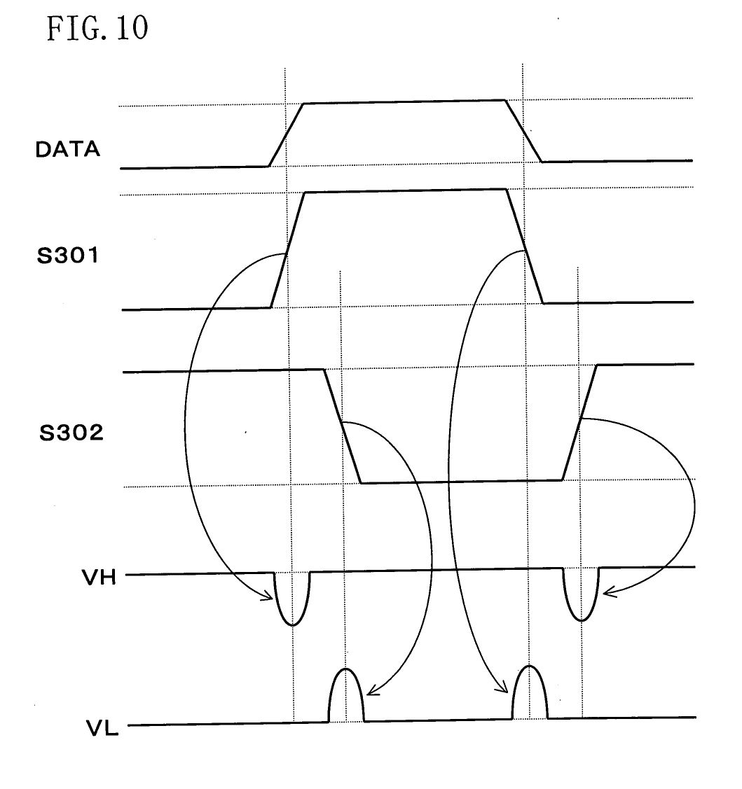

Next, an operation of the signal transfer circuit 3 of FIG. 9 will be described with reference to FIG. 10.

When the polarity of the display data signal DATA is transitioned, the inverter circuit 302 starts an operation reverse to the buffer circuit 301 with a delay from a charging or discharging operation performed by the buffer circuit 301. Thereby, an output S301 of the buffer circuit 301 is transitioned, and thereafter, an output S302 of the inverter circuit 302 is transitioned. In this case, voltage variations caused by the buffer circuit 301 and the inverter circuit 302 occur in the respective different power supply wirings.

Also, the signal wiring L3 is divided by the inverter circuit 302. Therefore, voltage variations of the buffer circuit 301 and the inverter circuit 302 both can be caused to be smaller than when a single stage of a buffer circuit or a single stage of an inverter circuit is used to charge or discharge the signal wiring L1.

As described above, charging and discharging of the load capacitance are shared by the buffer circuits 301 and 302, and the inverter circuit 302 performs an operation reverse to that of the buffer circuit 301, so that the voltage variations of the power supply wirings HHH and LLL can be reduced.

Note that, even when the buffer circuit 301 is replaced with an inverter circuit, the inverter circuit 302 performs a reverse operation, thereby making it possible to obtain a similar effect. Also, a buffer circuit or an inverter circuit may be added to the signal wiring L3.

### Fourth Embodiment

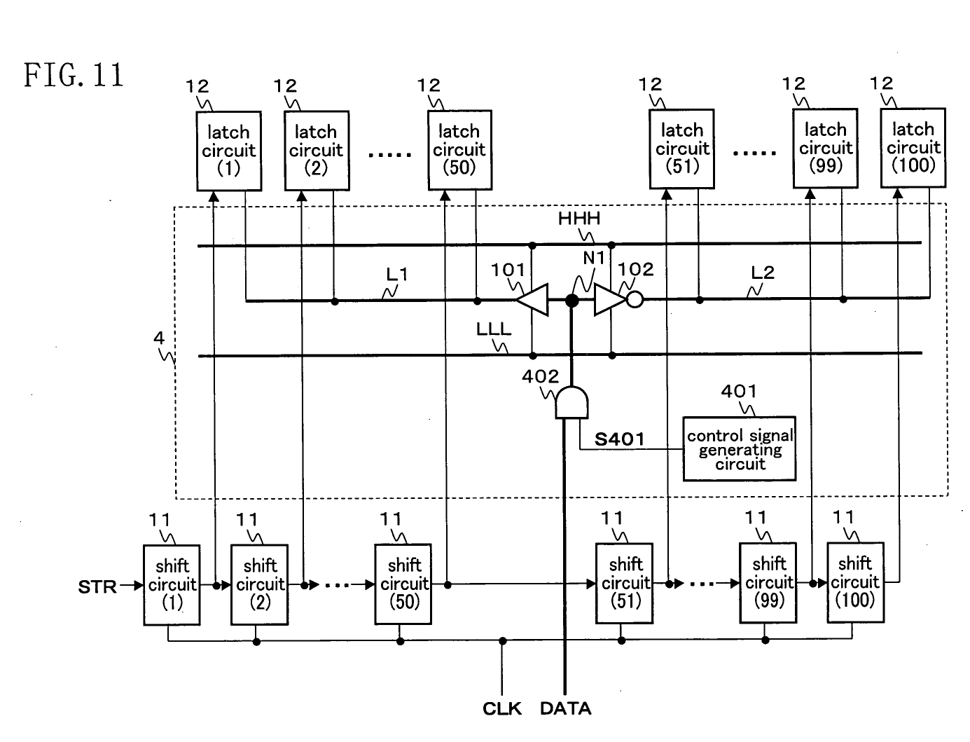

FIG. 11 shows a configuration of a signal transfer circuit according to a fourth embodiment of the present invention. This signal transfer circuit 4 comprises a control signal generating circuit 401 and a logic circuit 402 in addition to the parts of FIG. 1. The logic circuit 402 (control circuit) has a signal supply mode in which the display data signal DATA is passed to the input node N1, and a voltage fixing mode in which a voltage at the input node N1 is fixed to the low level. The operation modes are switched in accordance with a control signal S401 from the control signal generating circuit 401.

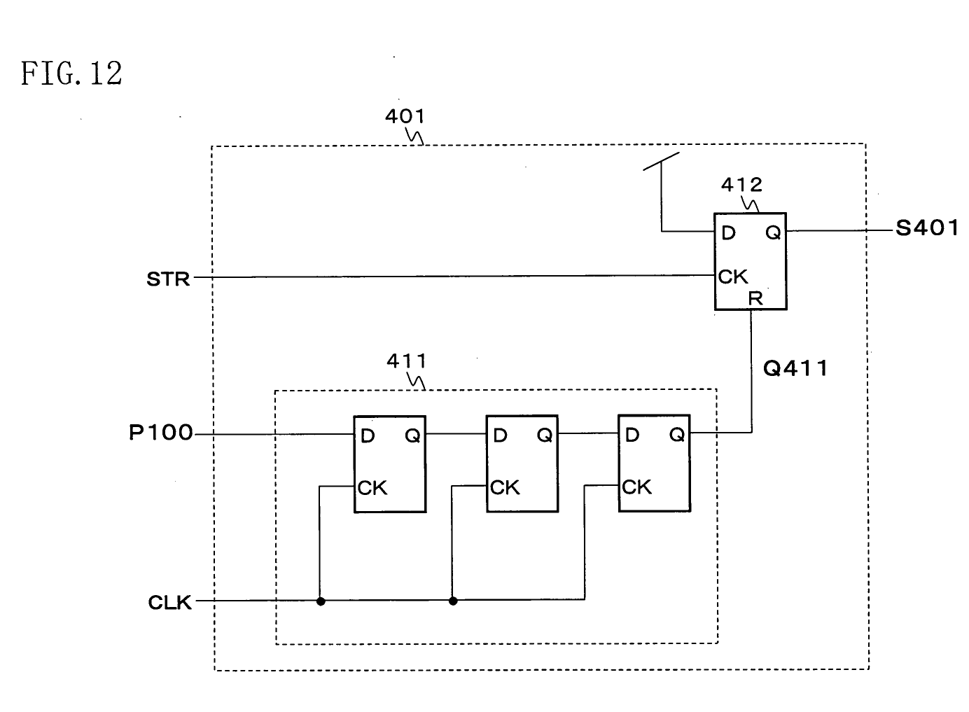

FIG. 12 shows an exemplary configuration of the control signal generating circuit 401 of FIG. 11. The control signal generating circuit 401 includes a delaying section 411 and a flip-flop 412. The delaying section 411, which is formed of, for example, a group of flip-flops, delays a pulse signal P100 output from the 100th-stage shift circuit 11 by several clocks and outputs the result as a reset signal Q411. The flip-flop 412 causes its own output (the control signal S401) to go to the high level in synchronization with the start pulse signal STR, and causes the control signal S401 to go to the low level when the reset signal Q411 goes to the high level.

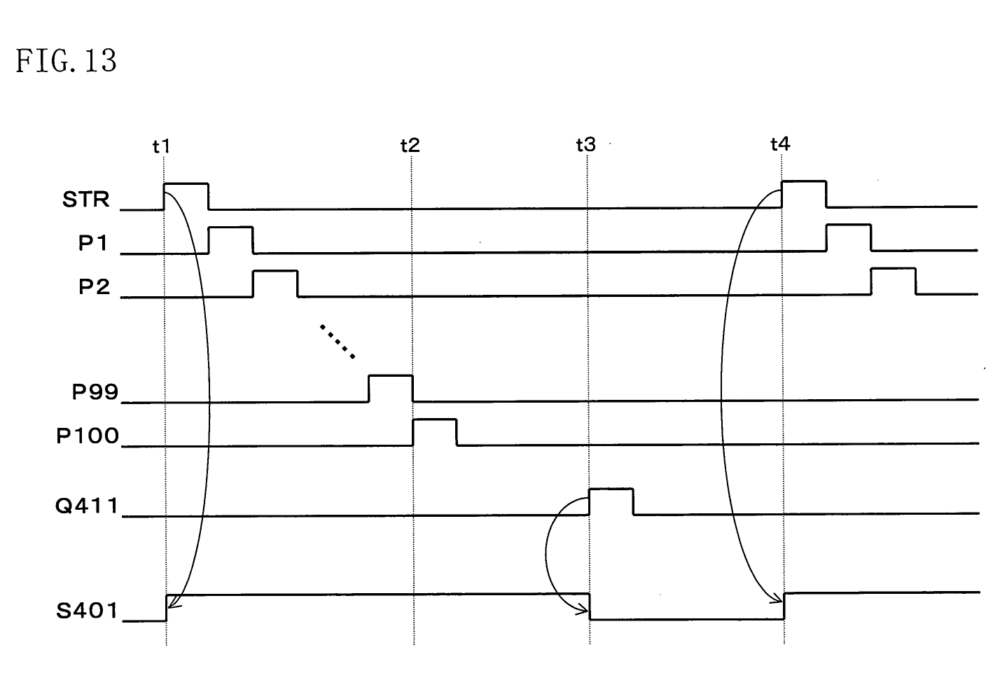

Next, an operation of the signal transfer circuit 4 of FIG. 11 will be described with reference to FIG. 13.

At time t1, the start pulse signal STR is input to the first-stage shift circuit 11 and the control signal generating circuit 401, so that the control signal S401 goes from the low level to the high level, and therefore, the logic circuit 402 passes the display data signal DATA to the input node N1. Thereby, the display data signal DATA is transferred via the buffer circuit 101 and the inverter circuit 102 to the signal wirings L1 and L2, respectively. The first-stage latch circuit 12 latches the display data signal DATA in synchronization with a pulse signal P1 from the first-stage shift circuit 11.

During a period of time from time t1 to time t2, the start pulse signal STR is sequentially transferred from the first-stage shift circuit 11 in synchronization with the internal clock signal CLK. Pulse signals P2, . . . , P99 are successively output from the second-stage to 99th-sage shift circuits 11, respectively. At time t2, the pulse signal P100 is output from the 100th-stage shift circuit 11. Thus, the first-stage to 100th-stage latch circuits 12 have latched the display data signal DATA.

When several clocks have passed since the output of the pulse signal P100 from the 100th-stage shift circuit 11 (time t3), the reset signal Q411 rises, so that the control signal S401 goes from the high level to the low level, in the control signal generating circuit 401. Thereby, the logic circuit 402 fixes the voltage at the input node N1 to the low level.

Next, at time t4, the start pulse signal STR is input to the first-stage shift circuit 11 and the control signal generating circuit 401 again, so that the processes at times t1 to t3 are repeated.

As described above, by fixing the voltage at the input node N1 during a period of time during which a signal does not need to be transferred to each of the signal wirings L1 and L2, it is possible to prevent an erroneous operation of the buffer circuit 101 and the inverter circuit 102, so that current consumption can be reduced in the buffer circuit 101 and the inverter circuit 102.

Note that, in the control signal generating circuit 401, a signal relating to the start pulse signal STR (specifically, a pulse signal which rises during a time from when the pulse signal P100 is output to when the start pulse signal STR is input) may be input to a clock terminal of the flip-flop 412 instead of the start pulse signal STR. Also, the pulse signal P100 from the 100th-stage shift circuit 11 may be input directly to a reset terminal of the flip-flop 412 without via the delaying section 411. Further, a counter circuit may be additionally provided so that a signal from the counter circuit is input to the flip-flop 412 instead of a pulse signal from the shift circuit 11. Specifically, during the whole or a part of a period of time during which none of the 100 stages of latch circuits 12 performs a latch process (in FIG. 13, a period of time from when the pulse signal P100 falls to when the pulse signal P1 rises), the logic circuit 402 may go to the voltage fixing mode. Note that, during a period of time from when the first-stage latch circuit 12 starts a latch process to when the 100th-stage latch circuit 12 completes a latch process, the operation mode of the logic circuit 402 needs to be set to be the signal supply mode.

Also, the configuration of the control signal generating circuit 401 is not limited to that of FIG. 12. For example, in the control signal generating circuit 401, even if the flip-flop 412 is replaced with an RS latch circuit, the control signal S401 can be generated. Also, even if the logic circuit 402 is replaced with a select circuit which selectively outputs the display data signal DATA and the voltage of the low-level power supply wiring LLL, a similar effect can be obtained. Specifically, such a select circuit selects and outputs the display data signal DATA during a period of time during which the control signal S401 is at the high level, and the voltage of the low-level power supply wiring LLL during a period of time during which the control signal S401 is at the low level.

Further, the control signal generating circuit 401 and the logic circuit 402 of this embodiment are also applicable to the signal transfer circuits of FIGS. 4, 6, 8 and 9.

### Fifth Embodiment

FIG. 11 shows a configuration of a signal transfer circuit according to a fifth embodiment of the present invention. This signal transfer circuit 5 comprises a control signal generating circuit 501 and logic circuits 502A and 502B in addition to the parts of FIG. 1.

The logic circuit 502A (first control circuit) has a signal supply mode in which a signal input to the input node N1 is passed to the input terminal of the buffer circuit 101 and a voltage fixing mode in which a voltage at the input terminal of the buffer circuit 101 is fixed to the low level. The operation modes are switched in accordance with a control signal S501A from the control signal generating circuit 501.

The logic circuit 502B (second control circuit) has a signal supply mode in which a signal input to the input node N1 is passed to the input terminal of the inverter circuit 102 and a voltage fixing mode in which a voltage at the input terminal of the inverter circuit 102 is fixed to the low level. The operation modes are switched in accordance with a control signal S501B from the control signal generating circuit 501.

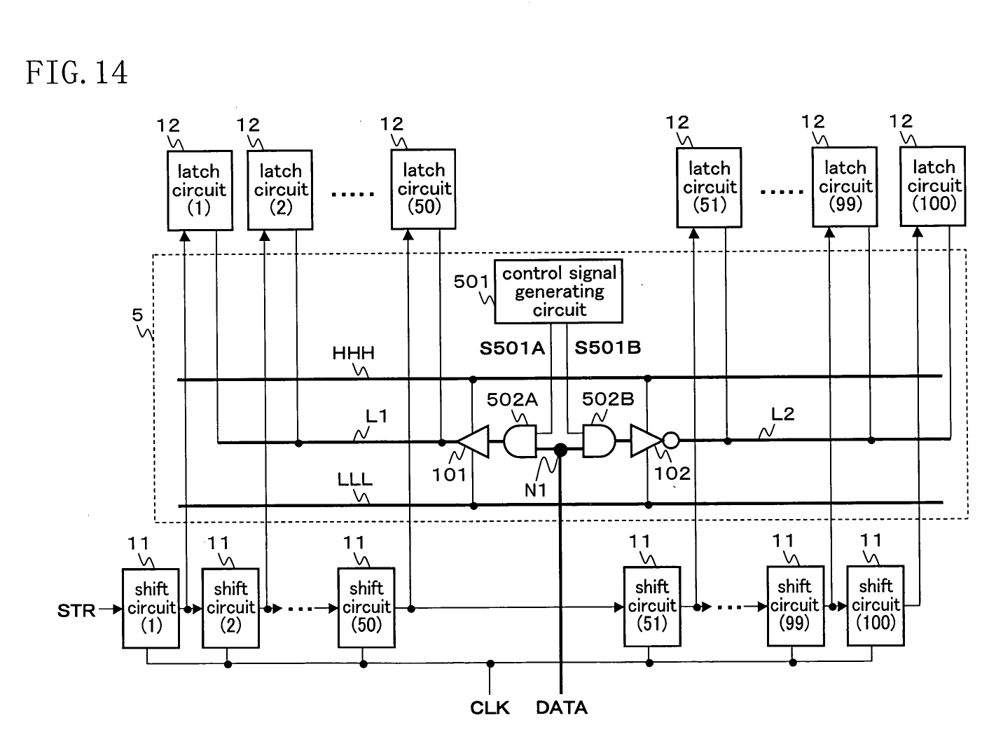

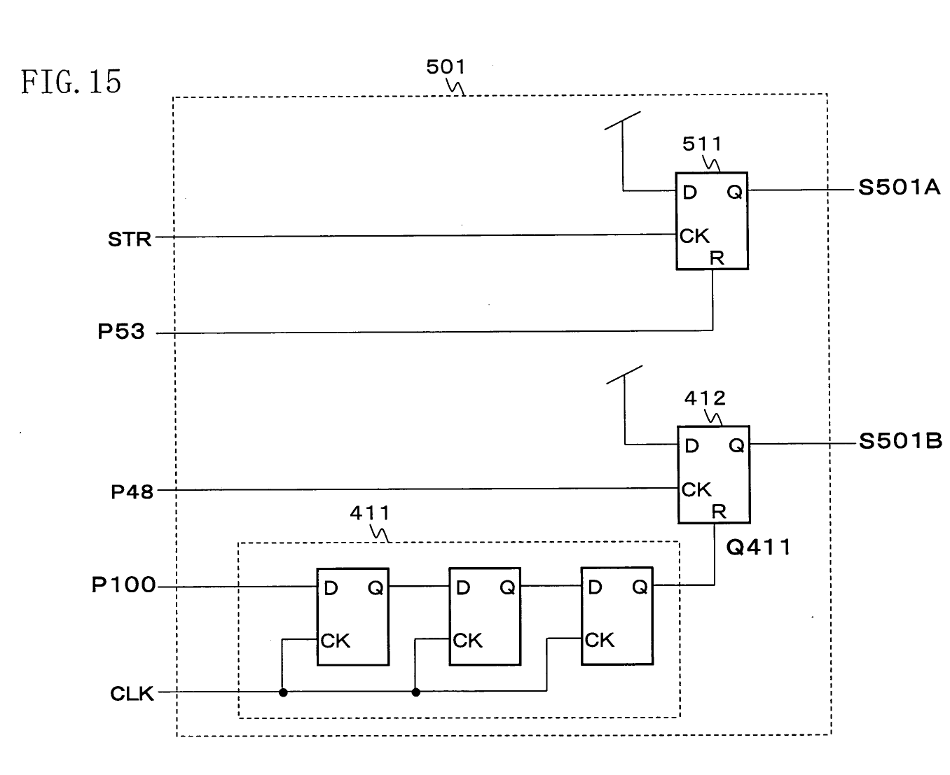

FIG. 15 shows an exemplary configuration of the control signal generating circuit 501 of FIG. 14. The control signal generating circuit 501 further includes a flip-flop 511 in addition to the parts of FIG. 12. The flip-flop 511 causes its own output (the control signal S501A) to go to the high level in synchronization with the start pulse signal STR, and causes the control signal S501A to go to the low level when receiving a pulse signal P53 output from the 53rd-stage shift circuit 11. Also, here, the flip-flop 412 receives a pulse signal P48 from the 48th-stage shift circuit 11 instead of the start pulse signal STR, and causes its own output (the control signal S501B) to go to the high level in synchronization with the pulse signal P48.

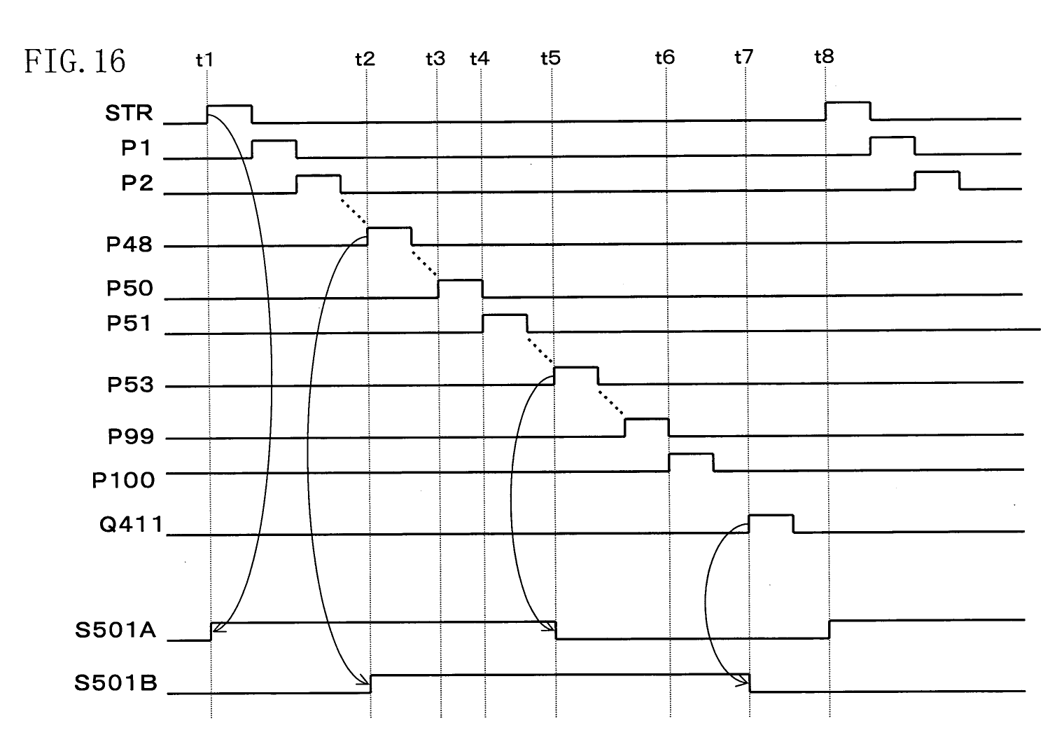

Next, an operation of the signal transfer circuit 5 of FIG. 14 will be described with reference to FIG. 16.

At time t1, the start pulse signal STR is input to the first-stage shift circuit 11 and the control signal generating circuit 501, so that the control signal S501A goes from the low level to the high level, and therefore, the logic circuit 502A passes the display data signal DATA to the buffer circuit 101. Thereby, the display data signal DATA is transferred via the buffer circuit 101 to the signal wiring L1. On the other hand, since the control signal S501B remains at the low level, the logic circuit 502B continues to fix the voltage at the input terminal of the inverter circuit 102 to the low level.

At time t2, the 48th-stage shift circuit 11 outputs the pulse signal P48, so that the control signal S501B goes from the low level to the high level, and therefore, the logic circuit 502B passes the display data signal DATA to the inverter circuit 102. Thereby, the display data signal DATA is also transferred via the inverter circuit 102 to the signal wiring L2.

At time t3, the 50th-stage shift circuit 11 outputs a pulse signal P50, so that the 50th-stage the latch circuit 12 performs a latch process. Thus, the 50 stages of latch circuits 12 connected to the signal wiring L1 each have completed a latch process.

Next, at time t4, the 51st-stage shift circuit 11 outputs a pulse signal P51, so that the 51st-stage the latch circuit 12 latches the display data signal DATA from the signal wiring L2 in synchronization with the pulse signal P51.

At time t5, the 53rd-stage shift circuit 11 outputs the pulse signal P53, so that the control signal S501A goes from the high level to the low level, and therefore, the logic circuit 502A fixes the voltage at the input terminal of the buffer circuit 101 to the low level.

At time t6, the 100th-stage shift circuit 11 outputs a pulse signal P100. Thus, the first-stage to 100th-stage latch circuit 12 each have latched the display data signal DATA.

At time t7, in the control signal generating circuit 501, the reset signal Q411 rises, so that the control signal S501B goes from the high level to the low level. Thereby, the logic circuit 502B fixes the voltage at the input terminal of the inverter circuit 102 to the low level.

Next, at time t8, the start pulse signal STR is input to the first-stage shift circuit 11 and the control signal generating circuit 501 again, and the processes at time t1 to time t7 are repeated.

As described above, the logic circuit 502A fixes the voltage at the input terminal of the buffer circuit 101 to the low level during a period of time during which a signal does not need to be transferred to the signal wiring L1, while the logic circuit 502B fixes the voltage at the input terminal of the inverter circuit 102 to the low level during a period of time during which a signal does not need to be transferred to the signal wiring L2. Thereby, a period of time during which the input terminal of each of the buffer circuit 101 and the inverter circuit 102 is fixed to the low level can be elongated, so that current consumption of each of the buffer circuit 101 and the inverter circuit 102 can be further reduced.

Note that the logic circuit 502A may be in the voltage fixing mode during the whole or a part of a period of time during which none of the first-stage to 50th-stage latch circuits 12 (i.e., the latch circuits 12 connected to the signal wiring L1) performs a latch process (in FIG. 16, a period of time from when the pulse signal P50 rises to when the pulse signal P1 falls). Note that the operation mode of the logic circuit 502A needs to be the signal supply mode during a period of time from when the first-stage latch circuit 12 starts a latch process to when the 50th-stage latch circuit 12 completes a latch process.

Also, the logic circuit 502B may be in the voltage fixing mode during the whole or a part of a period of time during which none of the 51st-stage to 100th-stage latch circuits 12 (i.e., the latch circuits 12 connected to the signal wiring L2) performs a latch process (in FIG. 16, a period of time from when the pulse signal P100 falls to when the pulse signal P51 rises). Note that the operation mode of the logic circuit 502B needs to be the signal supply mode during a period of time from when the 51 st-stage latch circuit 12 starts a latch process to when the 100th-stage latch circuit 12 completes a latch process.

Further, the control signal generating circuit 501 and the logic circuits 502A and 502B of this embodiment are applicable to the signal transfer circuits of FIGS. 4, 6 and 8.

### Other Embodiments

In each of the above-described embodiments, the overall current driving performance of the input/output circuit(s) (the buffer circuit 101 in FIG. 1, and the buffer circuit 101 and the inverter circuit 104 in FIG. 4) which outputs an output signal having the same polarity as that of the display data signal DATA input to the input node N1, and the overall current driving performance of the input/output circuit(s) (the inverter circuit 102 in FIG. 1, and the inverter circuits 102 and 103 in FIG. 4) which outputs an output signal having a polarity opposite to that of the display data signal DATA input to the input node N1, are preferably caused to be equal to each other. With such a configuration, the amount of a current supplied from the power supply wiring HHH by a charging operation and the amount of a current extracted to the power supply wiring LLL by a discharging operation can be caused to be equal to each other, so that the voltage variation amounts of the power supply wirings HHH and LLL can be minimized.

Also, although it has been assumed in each embodiment above that the signal transfer circuit transfers the display data signal DATA, the signal transfer circuit can also be used as a circuit which transfers the internal clock signal CLK or the second latch signal SSS. In particular, if signal transfer circuits having the same configuration are applied to the data signal wiring for transferring the display data signal DATA and the clock signal wiring for transferring the clock signal CLK, a difference in delay between the display data signal DATA and the clock signal CLK can be caused to be small, so that the latch circuit 12 can latch the display data signal DATA correctly.

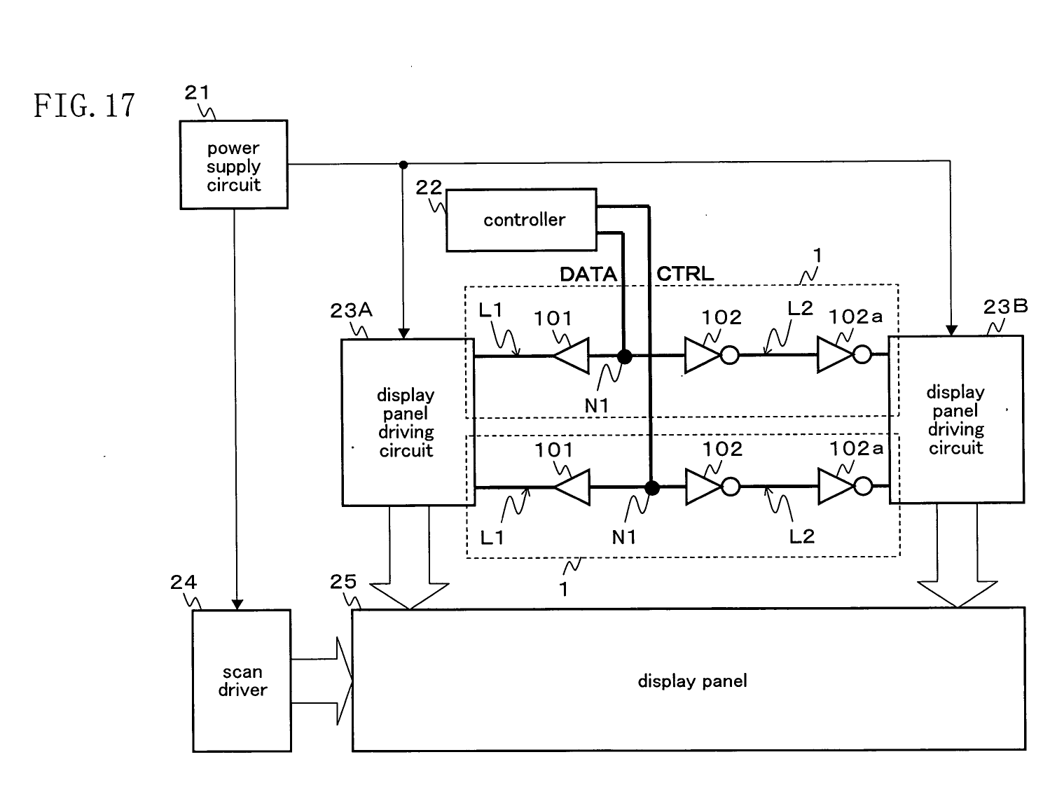

Also, as shown in FIG. 17, the signal transfer circuit of each embodiment above is not limited to a display panel driving circuit, and is also applicable to a display apparatus comprising a display panel driving apparatus. In FIG. 17, a display apparatus comprises a power supply circuit 21, a controller 22, a scan driver 24, and a display panel 25 in addition to two signal transfer circuits 1 and display panel driving apparatuses 23A and 23B. The power supply circuit 21 supplies a power supply voltage to each part. The controller 22 outputs a control signal CTRL (for example, the second latch signal SSS) for controlling the display panel driving apparatuses 23A and 23B along with the display data signal DATA. The display panel driving apparatuses 23A and 23B are controlled by the controller 22 to supply to the display panel 25 a gray-scale voltage having a voltage value depending on the display data signal DATA. Here, the load of driving the display panel 25 is shared by the display panel driving apparatuses 23A and 23B. In this display apparatus, the signal transfer circuit 1 is used as a data bus for transferring the display data signal DATA from the controller 22 or as a control wiring for transferring the control signal CTRL. Also, the signal transfer circuit 1 comprises an inverter circuit 102a in addition to the parts of FIG. 1 so as to bring a signal inversed by the inverter circuit 102 back to the original polarity (note that the power supply wirings HHH and LLL are not shown).

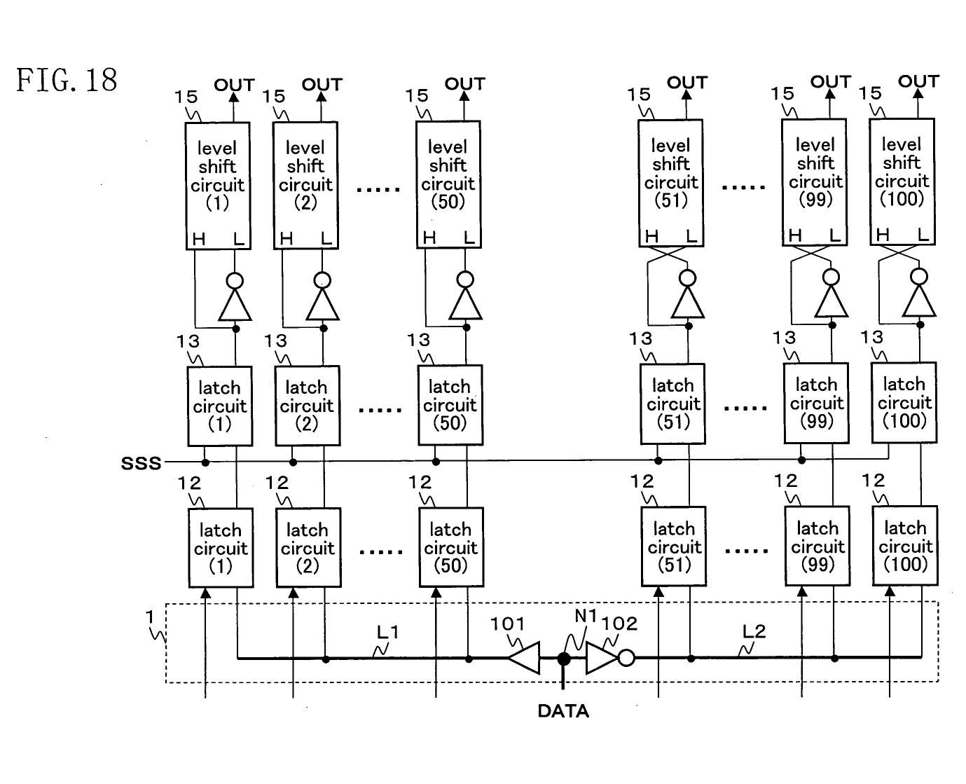

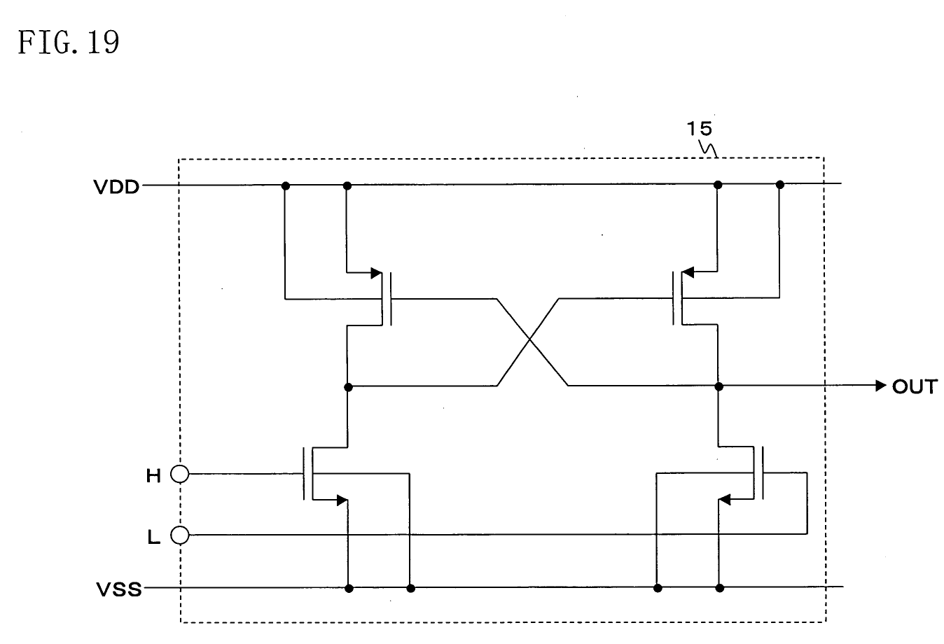

Although the inverter circuit 14 is provided between the latch circuits 12 and 13 so as to bring the display data signal DATA back to the original polarity in each embodiment above, the present invention is not limited to this. As shown in FIG. 18, the connection of the latch circuit 13 to a level shift circuit 15 may be modified (note that the power supply wirings HHH and LLL are not shown). In FIG. 18, the first-stage to 50th-stage level shift circuits 15 each receive a non-inverted output of a latch circuit 13 corresponding to the level shift circuit 15 at a positive polarity terminal H thereof, and an inverted output of the latch circuit 13 at a negative polarity terminal L thereof. On the other hand, the 51 st-stage to 100th-stage level shift circuits 15 each receive an inverted output of a latch circuit 13 corresponding to the level shift circuit 15 at a positive polarity terminal H thereof, and a non-inverted output of the latch circuit 13 at a negative polarity terminal L thereof. The level shift circuit 15 has, for example, a configuration as shown in FIG. 19. With such a configuration, the display data signal DATA is brought back to the original polarity.

As described above, the signal transfer circuit of the present invention can reduce a voltage variation of a power supply wiring, thereby making it possible to suppress EMI, for example. Therefore, the signal transfer circuit of the present invention is particularly useful as a display panel driving apparatus for driving a display panel (e.g., a liquid crystal panel, etc.), a display apparatus comprising such a display panel driving apparatus, or the like.

What is claimed is:

1. A signal transfer circuit for transferring a signal input to an input node, comprising:
a first input/output circuit and a second input/output circuit each having an input terminal connected to the input node;
a first signal wiring extending from an output terminal of the first input/output circuit;
a second signal wiring extending from an output terminal of the second input/output circuit;
a first power supply wiring for supplying a first voltage; and
a second power supply wiring for supplying a second voltage which is lower than the first voltage,
wherein the first and second input/output circuits each select any one of the first and second power supply wirings, depending on the polarity of an input signal, to output an output signal, and have any one of a first characteristic in which an output signal having the same polarity as that of the input signal is output and a second characteristic in which an output signal having a polarity opposite to that of the input signal is output, and the characteristics possessed by the first and second input/output circuits are different from each other.

2. The signal transfer circuit of claim 1, further comprising:
P (P is a natural number) input/output circuits,
wherein the P input/output circuits each have any one of the first and second characteristics, and are each provided for any one of the first and second signal wirings.

3. The signal transfer circuit of claim 2, wherein an overall current driving performance of an input/output circuit or input/output circuits outputting an output signal having the same polarity as that of the signal input to the input node is equal to an overall current driving performance of an input/output circuit or input/output circuits outputting an output signal having a polarity opposite to that of the signal input to the input node.

4. The signal transfer circuit of claim 1, further comprising:
a first control circuit provided between the input node and the input terminal of the first input/output circuit, and capable of switching a signal supply mode in which the signal input to the input node is passed to the input terminal of the first input/output circuit and a voltage fixing mode in which a voltage at the input terminal of the first input/output circuit is fixed; and
a second control circuit provided between the input node and the input terminal of the second input/output circuit, and capable of switching a signal Supply mode in which the signal input to the input node is passed to the input terminal of the second input/output circuit and a voltage fixing mode in which a voltage at the input terminal of the second input/output circuit is fixed.

5. A display data processing apparatus for capturing a display data signal, for use in a driving apparatus for driving a display panel, comprising:
the signal transfer circuit of claim 4;
a plurality of shift circuits connected in series; and
a plurality of latch circuits corresponding to the plurality of shift circuits,
wherein the display data signal is input to the input node,
the first-stage shift circuit receives a start pulse signal, and each of the plurality of shift circuits sequentially transfers a pulse signal from the previous stage to the next stage,
each of the plurality of latch circuits is connected to any one of the first and second signal wirings, and latches the display data signal transferred to the signal wiring in synchronization with a pulse signal from the corresponding shift circuit,
the first control circuit is in the voltage fixing mode during the whole or a part of a period of time during which none of the latch circuits connected to the first signal wiring performs a latch process, and
the second control circuit is in the voltage fixing mode during the whole or a part of a period of time during which none of the latch circuits connected to the second signal wiring performs a latch process.

6. A display apparatus comprising:
a display panel driving apparatus including the display data processing apparatus of claim 5; and
a display panel driven by the display panel driving apparatus.

7. The signal transfer circuit of claim 1, further comprising:
a control circuit capable of switching a signal supply mode in which a signal is supplied to the input node and a voltage fixing mode in which a voltage at the input node is fixed.

8. A display data processing apparatus for capturing a display data signal, for use in a driving apparatus for driving a display panel, comprising:
the signal transfer circuit of claim 7;
a plurality of shift circuits connected in series; and
a plurality of latch circuits corresponding to the plurality of shift circuits,
wherein the display data signal is input to the input node,
the first-stage shift circuit receives a start pulse signal and each of the plurality of shift circuits sequentially transfer a pulse signal from the previous stage to the next stage,
each of the plurality of latch circuits is connected to the signal wiring, and latches the display data signal transferred to the signal wiring in synchronization with a pulse signal from the corresponding shift circuit, and
the control circuit is in the voltage fixing mode during the whole or a part of a period of time during which none of the plurality of latch circuits performs a latch process.

9. A display apparatus comprising:
a display panel driving apparatus including the display data processing apparatus of claim 8; and
a display panel driven by the display panel driving apparatus.

10. The signal transfer circuit of claim 1, wherein a current driving performance of the first input/output circuit is equal to a current driving performance of the second input/output circuit.

11. A signal transfer circuit for transferring a signal input to an input node, comprising:
a first input/output circuit and a second input/output circuit each having an input terminal connected to the input node;
a first signal wiring extending from an output terminal of the first input/output circuit;
a second signal wiring extending from an output terminal of the second input/output circuit;
a third input/output circuit provided for the first signal wiring;
a first power supply wiring for supplying a first voltage; and
a second power supply wiring for supplying a second voltage which is lower than the first voltage,
wherein the first, second and third input/output circuits each select any one of the first and second power supply wirings, depending on the polarity of an input signal, to output an output signal,
the first and second input/output circuits have any one of a first characteristic in which an output signal having the same polarity as that of the input signal is output and a second characteristic in which an output signal having a polarity opposite to that of the input signal is output, and the characteristics possessed by the first and second input/output circuits are the same, and
the third input/output circuit has the second characteristic.

12. The signal transfer circuit of claim 11, further comprising:
P (P is a natural number) input/output circuits,
wherein the P input/output circuits each have any one of the first and second characteristics, and are each provided for any one of the first and second signal wirings.

13. The signal transfer circuit of claim 12, wherein an overall current driving performance of an input/output circuit or input/output circuits outputting an output signal having the same polarity as that of the signal input to the input node is equal to an overall current driving performance of an input/output circuit or input/output circuits outputting an output signal having a polarity opposite to that of the signal input to the input node.

14. The signal transfer circuit of claim 11, further comprising:
a first control circuit provided between the input node and the input terminal of the first input/output circuit, and capable of switching a signal supply mode in which the signal input to the input node is passed to the input terminal of the first input/output circuit and a voltage fixing mode in which a voltage at the input terminal of the first input/output circuit is fixed; and
a second control circuit provided between the input node and the input terminal of the second input/output circuit, and capable of switching a signal supply mode in which the signal input to the input node is passed to the input terminal of the second input/output circuit and a voltage fixing mode in which a voltage at the input terminal of the second input/output circuit is fixed.

15. A display data processing apparatus for capturing a display data signal, for use in a driving apparatus for driving a display panel, comprising:
the signal transfer circuit of claim 14;
a plurality of shift circuits connected in series; and
a plurality of latch circuits corresponding to the plurality of shift circuits,
wherein the display data signal is input to the input node,
the first-stage shift circuit receives a start pulse signal, and each of the plurality of shift circuits sequentially transfers a pulse signal from the previous stage to the next stage,
each of the plurality of latch circuits is connected to any one of the first and second signal wirings, and latches the display data signal transferred to the signal wiring in synchronization with a pulse signal from the corresponding shift circuit,
the first control circuit is in the voltage fixing mode during the whole or a part of a period of time during which none of the latch circuits connected to the first signal wiring performs a latch process, and
the second control circuit is in the voltage fixing mode during the whole or a part of a period of time during which none of the latch circuits connected to the second signal wiring performs a latch process.

16. A display apparatus comprising:
a display panel driving apparatus including the display data processing apparatus of claim 15; and
a display panel driven by the display panel driving apparatus.

17. The signal transfer circuit of claim 11, further comprising:
a control circuit capable of switching a signal supply mode in which a signal is supplied to the input node and a voltage fixing mode in which a voltage at the input node is fixed.

18. A display data processing apparatus for capturing a display data signal, for use in a driving apparatus for driving a display panel, comprising:
the signal transfer circuit of claim 17;
a plurality of shift circuits connected in series; and
a plurality of latch circuits corresponding to the plurality of shift circuits,
wherein the display data signal is input to the input node,
the first-stage shift circuit receives a start pulse signal and each of the plurality of shift circuits sequentially transfer a pulse signal from the previous stage to the next stage,
each of the plurality of latch circuits is connected to the signal wiring, and latches the display data signal transferred to the signal wiring in synchronization with a pulse signal from the corresponding shift circuit, and
the control circuit is in the voltage fixing mode during the whole or a part of a period of time during which none of the plurality of latch circuits performs a latch process.

19. A display apparatus comprising:
a display panel driving apparatus including the display data processing apparatus of claim 18; and
a display panel driven by the display panel driving apparatus.

20. The signal transfer circuit of claim 11, wherein an overall current driving performance of the first and second input/output circuits is equal to a current driving performance of the third input/output circuit.

21. A signal transfer circuit for transferring a signal input to an input node, comprising:
a first input/output circuit having an input terminal connected to the input node;
a signal wiring extending from an output terminal of the first input/output circuit;
a second input/output circuit provided for the signal wiring;
a first power supply wiring for supplying a first voltage; and
a second power supply wiring for supplying a second voltage which is lower than the first voltage,
wherein the first and second input/output circuits each select any one of the first and second power supply wirings, depending on the polarity of an input signal, to output an output signal,
the first input/output circuit has any one of a first characteristic in which an output signal having the same polarity as that of the input signal is output and a second characteristic in which an output signal having a polarity opposite to that of the input signal is output, and
the second input/output circuit has the second characteristic.

22. The signal transfer circuit of claim 21, further comprising:
P (P is a natural number) input/output circuits,
wherein the P input/output circuits each have any one of the first and second characteristics, and are each provided for the signal wiring.

23. The signal transfer circuit of claim 22, wherein an overall current driving performance of an input/output circuit or input/output circuits outputting an output signal having the same polarity as that of the signal input to the input node is equal to an overall current driving performance of an input/output circuit or input/output circuits outputting an output signal having a polarity opposite to that of the signal input to the input node.

24. The signal transfer circuit of claim 21, further comprising:
a control circuit capable of switching a signal supply mode in which the signal is input to the input node and a voltage fixing mode in which a voltage at the input node is fixed.

25. A display data processing apparatus for capturing a display data signal, for use in a driving apparatus for driving a display panel, comprising:
the signal transfer circuit of claim 24;
a plurality of shift circuits connected in series; and
a plurality of latch circuits corresponding to the plurality of shift circuits,
wherein the display data signal is input to the input node,
the first-stage shift circuit receives a start pulse signal, and each of the plurality of shift circuits sequentially transfers a pulse signal from the previous stage to the next stage,
each of the plurality of latch circuits is connected to the signal wiring, and latches the display data signal transferred to the signal wiring in synchronization with a pulse signal from the corresponding shift circuit, and
the control circuit is in the voltage fixing mode during the whole or a part of a period of time during which none of the latch circuits performs a latch process.

26. A display apparatus comprising:
a display panel driving apparatus including the display data processing apparatus of claim 25; and
a display panel driven by the display panel driving apparatus.

27. The signal transfer circuit of claim 21, wherein a current driving performance of the first input/output circuit is equal to a current driving performance of the second input/output circuit.
